(19) United States
(12) Patent Application Publication
(10) Pub. No.: US 2026/0169350 A1
(43) Pub. Date: Jun. 18, 2026

(54) METHOD AND DEVICE FOR HIGH-QUALITY POLING LITHIUM NIOBATE DEVICES

(71) Applicant: University of Rochester, Rochester, NY (US)

(72) Inventors: Qiang Lin, Rochester, NY (US); Jingwei Ling, Rochester, NY (US); Jeremy Staffa, Westport, NY (US)

(21) Appl. No.: 19/129,424

(22) PCT Filed: Nov. 17, 2023
(86) PCT No.: PCT/US2023/080187

§ 371 Date: May 13, 2025

Related U.S. Application Data
(60) Provisional application No. 63/426,427, filed on Nov. 18, 2022.

(51) Int. Cl. G02F 1/355; G02F 1/365

(52) U.S. Cl. CPC G02F 1/3558; G02F 1/365; G02F 2202/20

(57) ABSTRACT

A method for poling an optical device to form a high quality optical device, comprises forming a lithium niobate (LN) thin film on a substrate, depositing one or more poling electrodes on the LN film, depositing a dielectric material having a dielectric constant of greater than about 20 on the LN film and the one or more poling electrodes to form a temporary cladding layer, applying an electric field across by use of the one or more poling electrodes and removing the temporary cladding layer to form an optical device. An optical device is also described.

### CROSS REFERENCE TO RELATED APPLICATION(S)

This application is a national stage application under 35 U.S.C. § 371 of PCT Application No. PCT/US2023/080187, filed Nov. 17, 2023, METHOD AND DEVICE FOR HIGH-QUALITY POLING LITHIUM NIOBATE DEVICES, published as WO 2024/108070A 1 , which claims priority to and the benefit of is a U.S. provisional patent application Ser. No. 63/426,427, METHOD AND DEVICE FOR HIGH-QUALITY POLING LITHIUM NIOBATE DEVICES, filed Nov. 18, 2022, the entire contents of which are incorporated by reference herein.

### BACKGROUND

The application relates to poling particularly to poling lithium niobate (LN) optical devices and waveguides. Lithium niobate (LN) provides enhanced electro-optic, acousto-optic, and nonlinear optical properties, and is currently used in fabrication of many micro-optical devices including various active and passive devices. However, conventional techniques for fabricating optical devices using conventional LN waveguides.

### SUMMARY

In accordance with one illustrative embodiment, a method for poling an optical device to form a high quality optical device, comprises forming a lithium niobate (LN) thin film on a substrate, depositing one or more poling electrodes on the LN film, depositing a dielectric material having a dielectric constant of greater than about 20 on the LN film and the one or more poling electrodes to form a temporary cladding layer, applying an electric field by use of the one or more poling electrodes and removing the temporary cladding layer to form an optical device.

In embodiments, the method include removing the one or more poling electrodes.

In some embodiments, applying an electric field comprises causing the electric field to be drawn into the LN film to establish a substantially uniform electric field distribution inside of the optical device. In certain embodiments, the dielectric material of the temporary cladding layer comprises a dielectric constant between about 20 and 1,000. In other embodiments, the dielectric material of the temporary cladding layer comprises a dielectric constant between about 20 and 10,000.

In embodiments, depositing a dielectric material comprises depositing one of glycerine or glycol on the LN film, to form the temporary cladding layer. In certain embodiments, depositing a dielectric material comprises depositing methanol on the LN film, to form the temporary cladding layer. In other embodiments, depositing a dielectric material comprises depositing water on the LN film, to form the temporary cladding layer. In certain embodiments, depositing a dielectric material comprises depositing at least one of water, acetaldehyde, acetone, acetonitrile, alcohol, ethyl (ethanol), methyl (methanol), propyl, benzonitrile, or glycerine, and combinations thereof on the LN film, to form the temporary cladding layer. In other embodiments, depositing a dielectric material comprises depositing at least one of Ta2O5, a TiO2, a SrTiO3, a ZrO2, a HfO2, a HfSiO4, a La2O3, a Y2O3, and a-LaAlO3, on the LN film, to form the temporary cladding layer.

An optical device formed in accordance with the method is provided.

In one illustrative embodiment, a method, comprises fabricating at least one waveguide on a lithium niobate (LN) thin film, depositing a plurality of poling electrodes on the waveguide, coating a top surface of the waveguide with a temporary cladding material having a dielectric constant greater than about 20, as an optical cladding, applying an electric field across the waveguide by use of the poling electrodes and removing the temporary cladding material to form an optical device.

In embodiments, the method further comprises removing the poling electrodes.

In some embodiments, the temporary cladding material has a dielectric constant between about 20 and 1,000, and is configured to draw the electric field into the waveguide to form a substantially uniform electric field distribution inside of the waveguide. In certain embodiments, the temporary cladding material has a dielectric constant between about 20 and 10,000, and is configured to draw the electric field into the waveguide to form a substantially uniform electric field distribution inside of the waveguide.

In one illustrative embodiment, an optical device, comprises a substrate, a lithium niobate (LN) thin film on a substrate forming a waveguide, one or more poling electrodes on the LN film configured to generate an electric field and a dielectric cladding layer on the LN thin film and the one or more poling electrodes where the dielectric cladding layer comprises a material having a dielectric constant of greater than about 20.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 is a schematic diagram illustrating a conventional poling method, where the poling is performed before the waveguide is fabricated;

FIG. 2 is a schematic diagram of an alternative poling method, where the poling is performed after the waveguide is fabricated;

FIG. 3 is a schematic diagram of an approach for high-quality poling of LN devices utilizing a high-dielectric medium as a cladding, according to one or more illustrative embodiments of the present disclosure;

FIG. 4A is a simulated electric field profile using air as the cladding, according to one or more illustrative embodiments of the present disclosure;

FIG. 4B is a simulated electric field profile using glycerine as the cladding, according to one or more illustrative embodiments of the present disclosure;

FIG. 4C is a simulated electric field profile using methanol as the cladding, according to one or more illustrative embodiments of the present disclosure; and

FIG. 4D is a simulated electric field profile using water as the cladding, according to one or more illustrative embodiments of the present disclosure.

### DETAILED DESCRIPTION

Optical frequency conversion based upon a quadratic optical nonlinearity is a powerful technology to transfer high-coherence laser radiation into new frequencies. Among various nonlinear media, lithium niobate (LN) is probably the most important nonlinear medium for frequency conversion that has found broad applications in commercial lasers, communication, integrated photonics, and quantum technology. In recent years, thin-film lithium-niobate-on-insulator (LNOI) platform appears as a very promising platform for nonlinear photonic integrated circuit (PIC) that not only boosts frequency conversion efficiency via strong mode confinement, but also enables multifunctionality via photonic integration with diverse active and passive functional elements.

The efficiency of frequency conversion generally relies on periodic poling of LN crystal, where the ferroelectric domain of LN is periodically inverted along the waveguide via electric poling, to achieve quasi-phase matching for the optical parametric process.

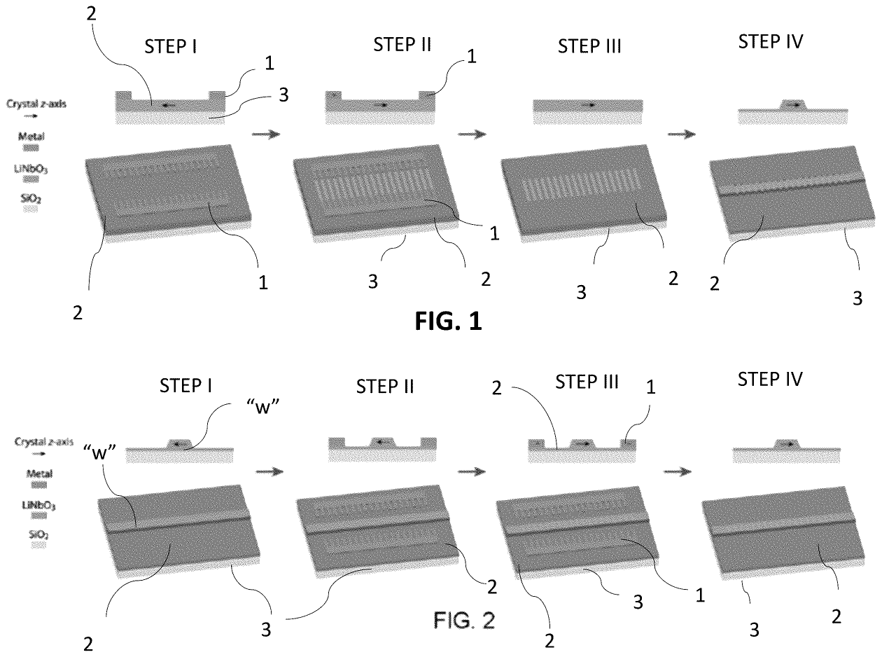

FIG. 1 is a schematic of a conventional poling method, where the poling is performed before the waveguide is fabricated. A set of comb-like electrodes 1 is deposited on the surface of a LN thin film 2 disposed on a silicon dioxide substrate 3 (Step I), and the material is periodically poled (Step II). In subsequent steps, the electrodes 1 are removed (Step III) and the optical waveguide is defined and patterned on the poled region (Step IV). Unfortunately, due to the selective etching of poled LN, the waveguide becomes irregular-shaped, for example, zig-zag-shaped, along the length of the waveguide, which seriously degrades its optical quality, leading to significant propagation loss. As selective etching is intrinsic to the LN material, this problem is challenging to resolve.

FIG. 2 is a schematic diagram of an alternative poling method, where the poling is performed after the waveguide is fabricated. In the alternative approach of FIG. 2, the optical waveguide “w” is defined and patterned first on the thin-film LN 2 which is disposed on the substrate 3 (Step I). The poling electrodes are then deposited on the surface (Step II) and are used to pole the LN waveguide (Step III). Thereafter, the electrodes may be removed (Step IV), or just left on the surface (Step III). As the waveguide is fabricated before poling, the waveguide quality is independent of the poling process and high optical quality remains after the waveguide is poled. Unfortunately, the LN has a dielectric constant (ε11≈44, ε≈28) which is significantly higher than air or silica. Consequently, the poling electric field does not uniformly penetrate into the LN waveguide, leading to degradation of poling quality. For at least the same reasoning, this method requires considerable layer thickness of the waveguide wing that the electrodes sit on, which seriously limits the engineering flexibility of the device and its functionality. An exemplary waveguide wing can be seen in FIG. 2, as the partially etched region of the waveguide on which the electrodes reside. This particularly becomes problematic in the visible or UV spectral regions where a thin or even completely removed waveguide wing is needed for dispersion engineering.

Accordingly, the present disclosure is directed to improvements over prior art poling methodologies. In accordance with one or more illustrative embodiments, a method for fabricating high-quality poling lithium niobate devices is provided. An illustrative method enables high-quality poling of LN devices while retaining high optical quality. In embodiments, a medium such as a liquid or solid with a dielectric constant greater than 20 can be used as a temporary cladding to draw or pull the electric field into the LN waveguide with a substantially uniform electric field distribution inside of the waveguide. This significantly improves the poling of the waveguide. In embodiments, the temporary cladding material can also have a dielectric constant between about 20 and 1,000, or, in embodiments, between about 20 and 10,000, to serve as an optical cladding. The temporary optical cladding causes the electric field to pull or be drawn into the optical device causing a substantially uniform electric field distribution inside of the optical device.

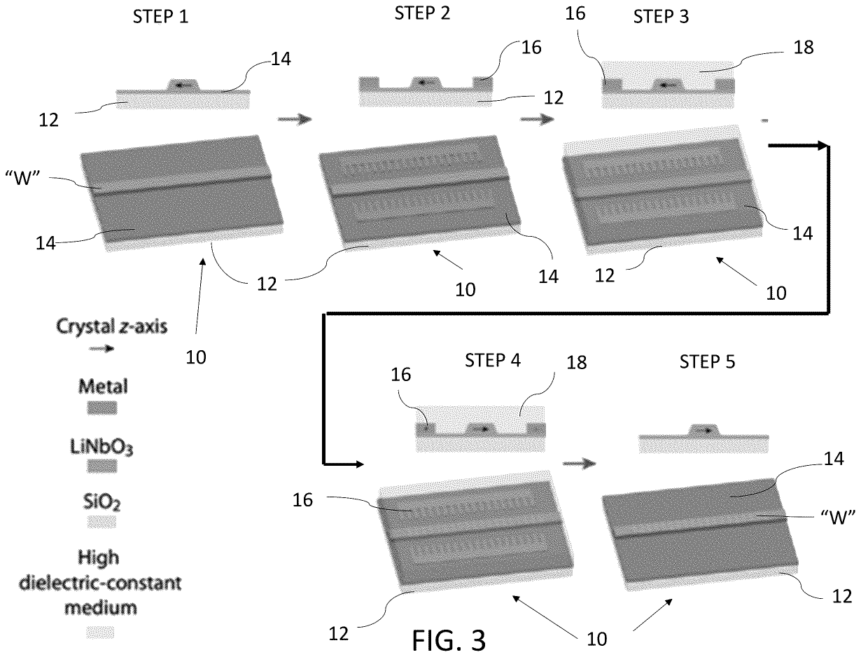

FIG. 3 is a schematic diagram of an illustrative approach for high-quality poling of LN devices utilizing a high-dielectric medium as a cladding according to one or more embodiments of the present disclosure is illustrated. The device includes a substrate 12 fabricated of, for example, silicon dioxide (SiO₂). A thin lithium niobate (LN) film is deposited on the substrate 12 via conventional deposition techniques. The lithium niobate (LN) film may comprise, in embodiments, LiNbO₃. The LN film may be etched via one or more etching processes to form one or more waveguides “W.” (STEP 1) The waveguide is fabricated on the LN thin film 14 and the poling electrodes 16 are deposited and formed on the LN film 14. (STEP 2) Thereafter, a high dielectric material is deposited on the device 10, to form a temporary high dielectric coating 18 on the top of the device as a cladding having a high dielectric constant (STEP 3) and the LN waveguide is then poled through administration of a poling electric field relative to the device (STEP 4). After the poling process, the high dielectric coating is removed (STEP 5). The poling electrodes could be removed or just left on the surface. The high-dielectric cladding dramatically improves the penetration of the poling electric field inside the waveguide core, including the LN film 14, leading to very uniform high-quality poling of the waveguide directly.

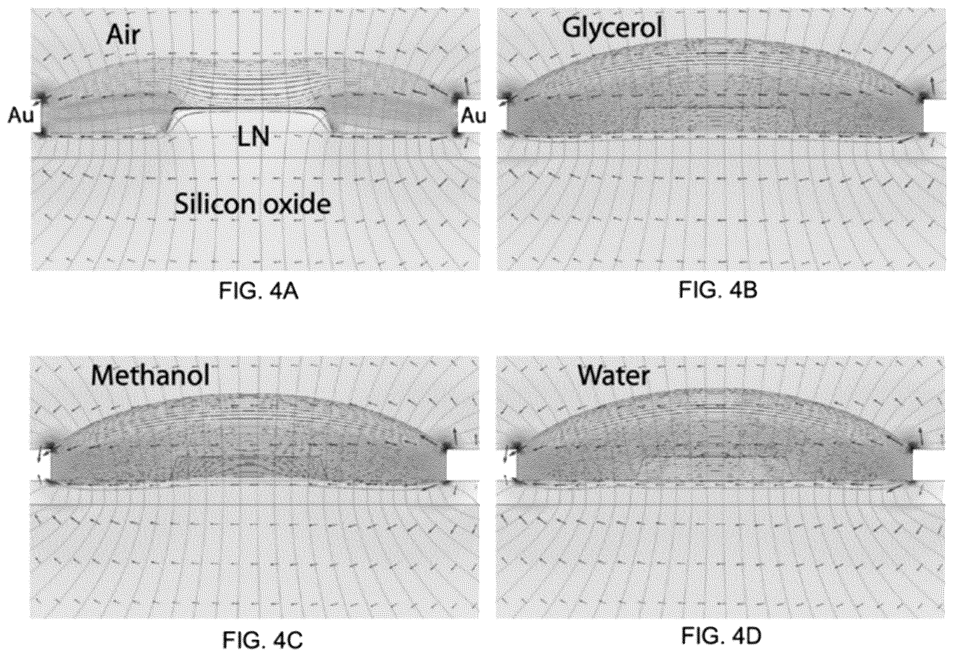

FIGS. 4A-4D illustrate numerically simulated electric field profiles with different cladding materials compared with air cladding in accordance with illustrative embodiments of the present disclosure. FIG. 4A to FIG. 4D are simulated by the finite-element method.

FIG. 4A is a simulated electric field profile using air as the cladding. When the waveguide uses air as the cladding, there is minimum penetration of the electric field into the LN waveguide core. Moreover, penetration of the electric field inside the LN waveguide is also non-uniform leading to a degraded poling quality.

FIG. 4B is a simulated electric field profile using glycerine, also referred to as glycerol, as the cladding. When glycerine is used as the cladding, in contrast, for example to air, the electric field is dramatically pulled into the LN waveguide and is substantially uniformly distributed inside the LN waveguide. As a result, the poling quality will be significantly improved.

FIG. 4C is a simulated electric field profile using methanol as the cladding. Using methanol and/or water as cladding has a similar effect.

FIG. 4D is a simulated electric field profile using water as the cladding.

In accordance with one or more embodiments of the present disclosure, a medium (liquid or solid) with a dielectric constant of greater than 20 produces a high quality poling effect in which the electric field is pulled or drawn into the LN waveguide and with substantially uniform electric field distribution inside of the waveguide.

The high-dielectric-constant medium can be any suitable liquid such as, for example, water, acetaldehyde, acetone, acetonitrile, alcohol, ethyl (ethanol), methyl (methanol), propyl, benzonitrile, or glycerine, and combinations thereof. Liquid has an advantage that it can be removed easily after poling. The high-dielectric-constant medium can also be a dielectric, such as, for example, Ta₂O₅, TiO₂, SrTiO₃, ZrO₂, HfO₂, HfSiO₄, La₂O₃, Y₂O₃, a-LaAIO₃, etc. The high-dielectric-constant medium could be removed after poling, or it could be left on if it doesn't affect the light propagation in waveguide.

Any suitable poling protocol can be used. Any suitable electric field strength can be used, typically about 10×10⁶ V/m to 75×10⁶ V/m, many of our experiments used a field of about 40 V/μm (40×10⁶ V/m). Any suitable pulse width, pulse repetition rate, pulse shape can be used. For example, we have successfully used millisecond pulses with pulse repetition rates on the order of 100 Hz.

One illustrative Example: A partially etched LN waveguide with about a 600nm thickness and about a 300 nm etching, a top waveguide ridge width of 1.75 μm and an etching sidewall angle of 70° was used for poling. The poling electrodes of comb shape with a period of about 4.3 um and duty cycle of about 40% are placed at two sides of the waveguide, with about a 3 μm gap between the electrodes and the waveguide. Poling was performed in a glycerine or a glycerol, with the chip/wafer soaked in the liquid or with a liquid drop covering the poling section. Ten (10) rectangular electrical pulses with 240 V and a duration of 10 ms were applied on the electrodes for poling, with the electrical field pointing at the opposite direction of the LN z-axis.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

### REFERENCES

1. Andreas Boes, Bill Corcoran, Lin Chang, John Bowers, and Arnan Mitchell. Status and potential of lithium niobate on insulator (LNOI) for photonic integrated circuits. Laser & Photonics Reviews, 12(4):1700256, 2018.
2.Lin Chang, Yifei Li, Nicolas Volet, Leiran Wang, Jon Peters, and John E Bowers. Thin film wavelength converters for photonic integrated circuits. Optica, 3(5):531-535, 2016.
3. Jia-Yang Chen, Zhao-Hui Ma, Yong Meng Sua, Zhan Li, Chao Tang, and Yu-Ping Huang. Ultra-efficient frequency conversion in quasi-phase-matched lithium niobate microrings. Optica, 6(9):1244-1245, 2019.
4. Malcolm H Dunn and Majid Ebrahimzadeh. Parametric generation of tunable light from continuous-wave to femtosecond pulses. Science, 286(5444):1513-1517, 1999.
5. Majid Ebrahim-Zadeh. Continuous-wave optical parametric oscillators. Handbook of Optics, 4:1-33, 2010.
6. Martin M Fejer. Nonlinear optical frequency conversion. Physics today, 47(5):25-33, 1994.
7. Usman A Javid, Jingwei Ling, Jeremy Staffa, Mingxiao Li, Yang He, and Qiang Lin. Ultrabroadband entangled photons on a nanophotonic chip. Physical Review Letters, 127(18):183601, 2021.
8. Yunfei Niu, Chen Lin, Xiaoyue Liu, Yan Chen, Xiaopeng Hu, Yong Zhang, Xinlun Cai, Yan-Xiao Gong, Zhenda Xie, and Shining Zhu. Optimizing the efficiency of a periodically poled LNOI waveguide using in situ monitoring of the ferroelectric domains. Applied Physics Letters, 116(10):101104, 2020.
9. Ashutosh Rao, Kamal Abdelsalam, Tracy Sjaardema, Amirmahdi Honardoost, Guillermo F Camacho-Gonzalez, and Sasan Fathpour. Actively-monitored periodic-poling in thin-film lithium niobate photonic waveguides with ultrahigh nonlinear conversion efficiency of 4600% W-1cm-2 . Optics express, 27(18):25920-25930, 2019.
10. Cheng Wang, Carsten Langrock, Alireza Marandi, Marc Jankowski, Mian Zhang, Boris Desiatov, Martin M Fejer, and Marko Loncăr. Ultrahigh-efficiency wavelength conversion in nanophotonic pe-riodically poled lithium niobate waveguides. Optica, 5(11):1438-1441, 2018.
11. M Yamada, N Nada, M Saitoh, and K Watanabe. First-order quasi-phase matched linbo3 waveguide periodically poled by applying an external field for efficient blue second-harmonic generation. Applied Physics Letters, 62(5):435-436, 1993.
12. Jie Zhao, Michael Ru\ddot{s}ing, Usman A Javid, Jingwei Ling, Mingxiao Li, Qiang Lin, and Shayan Mookherjea. Shallow-etched thin-film lithium niobate waveguides for highly-efficient second-harmonic generation. Optics Express, 28(13):19669-19682, 2020.
13. Di Zhu, Linbo Shao, Mengjie Yu, Rebecca Cheng, Boris Desiatov, C J Xin, Yaowen Hu, Jeffrey Holzgrafe, Soumya Ghosh, Amirhassan Shams-Ansari, et al. Integrated photonics on thin-film lithium niobate. Advances in Optics and Photonics, 13(2):242-352, 2021.

What is claimed is:

1. A method for poling an optical device to form a high quality optical device, comprising:
forming a lithium niobate (LN) thin film on a substrate;
depositing one or more poling electrodes on the LN film;
depositing a dielectric material having a dielectric constant of greater than about 20 on the LN film and the one or more poling electrodes to form a temporary cladding layer;
applying an electric field by use of the one or more poling electrodes; and
removing the temporary cladding layer to form an optical device.

2. The method of claim 1, further comprising removing the one or more poling electrodes.

3. The method of claim 1, wherein applying an electric field comprises causing the electric field to be drawn into the LN film to establish a substantially uniform electric field distribution inside of the optical device.

4. The method of claim 3, wherein the dielectric material of the temporary cladding layer comprises a dielectric constant between about 20 and 1,000.

5. The method of claim 3 wherein the dielectric material of the temporary cladding layer comprises a dielectric constant between about 20 and 10,000.

6. The method of claim 1, wherein depositing a dielectric material comprises depositing one of glycerine or glycol on the LN film, to form the temporary cladding layer.

7. The method of claim 1, wherein depositing a dielectric material comprises depositing methanol on the LN film, to form the temporary cladding layer.

8. The method of claim 1, wherein depositing a dielectric material comprises depositing water on the LN film, to form the temporary cladding layer.

9. The method of claim 1, wherein depositing a dielectric material comprises depositing at least one of water, acetaldehyde, acetone, acetonitrile, alcohol, ethyl (ethanol), methyl (methanol), propyl, benzonitrile, or glycerine, and combinations thereof on the LN film, to form the temporary cladding layer.

10. The method of claim 1, wherein depositing a dielectric material comprises depositing at least one of Ta₂O₅, a TiO₂, a SrTiO₃, a ZrO₂, a HfO₂, a HfSiO₄, a La₂O₃, a Y₂O₃, and a-LaAlO₃, on the LN film, to form the temporary cladding layer ..

11. An optical device formed in accordance with the method of claim 1.

12. A method, comprising:
fabricating at least one waveguide on a lithium niobate (LN) thin film;
depositing a plurality of poling electrodes on the waveguide;
coating a top surface of the waveguide with a temporary cladding material having a dielectric constant greater than about 20, as an optical cladding;
applying an electric field across the waveguide by use of the poling electrodes; and
removing the temporary cladding material to form an optical device.

13. The method of claim 12, further comprising removing the poling electrodes.

14. The method of claim 12, wherein the temporary cladding material has a dielectric constant between about 20 and 1,000, and is configured to draw the electric field into the waveguide to form a substantially uniform electric field distribution inside of the waveguide.

15. The method of claim 12, wherein the temporary cladding material has a dielectric constant between about 20 and 10,000, and is configured to draw the electric field into the waveguide to form a substantially uniform electric field distribution inside of the waveguide.

16. An optical device, which comprises:
a substrate;
a lithium niobate (LN) thin film on a substrate forming a waveguide;
one or more poling electrodes on the LN film configured to generate an electric field; and
a dielectric cladding layer on the LN thin film and the one or more poling electrodes, the dielectric cladding layer comprising a material having a dielectric constant of greater than about

20.
